(19) United States
(12) Patent Application Publication
(10) Pub. No.: US 2011/0017362 A1
(43) Pub. Date: Jan. 27, 2011

(54) STEEL FLAT PRODUCT HAVING A METALLIC COATING WHICH PROTECTS AGAINST CORROSION AND METHOD FOR PRODUCING A METALLIC ZN-MG COATING, WHICH PROTECTS AGAINST CORROSION, ON A STEEL FLAT PRODUCT

(75) Inventors: Wilhelm Warnecke, Hamminkeln (DE); Manfred Meurer, Rheinberg (DE); Jens Sommer, Seevetal (DE); Michael Steinhorst, Essen (DE)

Correspondence Address: THE WEBB LAW FIRM, P.C., 700 KOPPERS BUILDING, 436 SEVENTH AVENUE, PITTSBURGH, PA, 15219, US

(73) Assignee: THYSSENKRUPP STEEL EUROPE AG, Duisburg (DE)

(21) Appl. No.: 12/741,068

(22) PCT Filed: Nov. 3, 2008
(86) PCT No.: PCT/EP08/64888

§ 371 Date: Sep. 23, 2010

(30) Foreign Application Priority Data
Nov. 5, 2007 (EP) 07021462.2

(51) Int. Cl. B05D 3/02; B32B 15/18; C23C 2/28

(52) U.S. Cl. 148/533; 148/320

(57) ABSTRACT

A steel flat product having a Zn—Mg—Al coating. The coating, which in addition to zinc and unavoidable impurities, comprises in wt. %: Mg: 4-8%, Al: 0.5-1.8% and optionally one or more of the following: Si: <2%, Pb: <0.1%, Ti: <0.2%, Ni: <1%, Cu: <1%, Co: <0.3%, Mn: <0.5%, Cr: <0.2%, Sr: <0.5%, Fe: <3%, B: <0.1%, Bi: <0.1%, Cd: <0.1%, REM<0.2%, and Sn<0.5%. The steel flat product according to the invention is not only outstandingly protected against corrosion, but also welds well and coats well with an organic layer applied subsequently. The invention also relates to a method for producing a steel flat product having a Zn—Mg—Al coating.

The invention relates to a steel flat product having a metallic coating which protects against corrosion and to a method for producing such a metallic Zn—Mg coating, which protects against corrosion, on a steel flat product. The term “steel flat product” is hereby understood to mean steel strips and steel sheets.

A steel material coated with a Zn alloy is known from EP 1 199 376 A1, which is supposed to possess outstanding corrosion resistance because its Zn alloy coating has, in addition to zinc, (in wt. %) 2-19% Al, 2-10% Mg, 0.01-2% Si and, if necessary, contents of In, Bi, Sn, Ca, Be, Ti, Cu, Ni, Co, Cr, Mn, Fe, Sr. The Zn alloy can furthermore, in addition to the impurities which result as a consequence of the process, contain other elements whose total content, however, is limited to a maximum of 0.5%. Among the other elements, Pb and Sb should in each case not be present in amounts of more than 0.1%. In order to improve adhesion of the Zn layer to the steel substrate, an Ni intermediate layer can be firstly applied onto the steel substrate, onto which the Zn—Mg alloy coating is then applied.

According to EP 1 199 376 A1, the Zn—Mg coating is produced by hot-dip coating, by the steel strip being firstly warmed to a sufficient but unspecified bath-entry temperature and then by being conveyed through an appropriately alloyed Zn—Mg—Al—Si melt bath in the continuous pass. In order to prevent the development of primary, crystalline Mg2Si phases in the melt bath, the temperature of the melt bath should be, thereby, according to the known method, at least 450° C. At the same time, the melt bath temperature is to be limited to a maximum of 650° C., in order to ensure that the steel sheet, coated in the known way, has an optimum optical appearance.

In practice, it has become apparent that although steel sheets provided with a Zn—Mg—Al coating of the kind described in EP 1 199 376 A1 have a good resistance to corrosion, in exchange a distinctly reduced weldability and an only limited subsequent coatability, in particular phosphatability, have to be accepted. Due to these disadvantages, steel flat products coated in this way can only be used to a limited extent, in particular in the sector for producing components for car bodies.

Another method for producing an Mg-containing and Al-containing zinc coating on a steel substrate, in which this can be a steel strip, is known from EP 0 594 520 B1. According to this known method, the steel substrate to be coated is immersed in a melt bath which contains (in wt. %) 1-3.5% Mg, 0.5-1.5% Al and 0.0010-0.0060% Si. Accordingly, a metallic coating develops on the steel substrate, which is formed from a Zn—Mg alloy, the contents of Mg, Al and Si of which alloy are essentially the same as the contents of the melt bath. The temperature of the melt bath is 400-450° C. in this known method, the steel substrate being conveyed into the melt bath at a bath-entry temperature of 350-600° C.

According to EP 0 594 520 B1, by specifically adding low contents of Si, which takes place in proportion to the respective Al and Mg contents, it is supposed to be ensured that the surface of the steel substrate is uniformly wetted by the Zn—Mg—Al coating and that defective areas as far as possible are prevented. Nevertheless, steel sheets provided with metallic coatings of the type described in EP 0 594 520 B1 are only, in practice, inadequately resistant to corrosion.

Against this background, the object of the invention consisted of creating a steel flat product, provided with a ZN—Mg coating, which is not only outstandingly protected against corrosion but can be both welded well and coated well with a subsequently applied, organic layer. Furthermore, a method should be specified for producing steel flat products coated in such a manner.

In relation to the steel flat product, this object is achieved according to the invention by the steel flat product having the features specified in Claim 1. Advantageous embodiments of this product are specified in the claims referring back to Claim 1.

The previously mentioned object is achieved, according to the invention, in relation to the method by the procedural steps specified in Claim 10 being completed when producing a steel flat product provided with a Zn—Mg coating. Advantageous embodiments of this method are specified in the claims referring back to Claim 10.

A steel flat product according to the invention has a Zn—Mg—Al alloy coating based on zinc, whose contents of Mg with 4-8 wt. % and of Al with 0.5-1.8 wt. % are set such that an optimum balance is obtained between highly effective protection against corrosion, on the one hand, and good processing properties, on the other hand.

In the salt spray test, it could be proved that with steel flat products provided with a Zn—Mg—Al coating in the way according to the invention, red rust only forms after a length of time which also always meets the most stringent requirements.

To this end, the metallic coating applied on the respective steel substrate according to the invention, contains at least 4 wt. % and at most 8 wt. % magnesium. The comparably high Mg contents guarantee considerably improved protection against corrosion compared to the prior art.

At the same time, the zinc amount required for the coating is reduced by the high magnesium proportion which is considerably more favourable as regards material costs. A coating alloyed according to the invention can, therefore, also be more cost-effectively produced than coatings which possess lower contents of magnesium.

The high Mg content of a coating according to the invention also proves to have a positive effect in relation to the coefficients of friction during deformation. Thus, the Zn—Mg—Al coating alloyed according to the invention exhibits considerably reduced coefficients of friction compared to pure Zn coatings.

The proportions of Mg and Al, which in total in each case take up at least 4.5% of the layer weight and are significantly lighter in weight compared to Zn, prove to have a positive effect in relation to the total weight of the flat products obtained in the way according to the invention.

Steel flat products coated according to the invention prove to be particularly well suited to phosphating as a consequence of the low contents of Al, so that they can be, provided, for example, with an organic lacquer coating without any special, additional arrangements.

At the same time, the Al content of a Zn—Mg—Al coating applied according to the invention is proportioned so that a distribution of the aluminium in the coating results which is ideal for adhesion and weldability. Thus, it has emerged that with a coating according to the invention, low Al contents are present in an intermediate layer of sufficient thickness close to the surface, by means of which low Al contents an improved weldability is provided compared to conventionally formed sheets, although the Al content of the coating as a whole is at a level which effectively provides the coating according to the invention with strong corrosion protection.

Tests have shown that with a coating according to the invention, even without the presence of effective amounts of Si an adhesion and sealing is ensured on the substrate, by which considerably improved protection against corrosion is obtained compared to the prior art and the risk of crack formation and flaking during deformation are reduced to a minimum. Where required, the quality of the coating according to the invention can be, however, further improved by Si being present in it in effective amounts. The Si contents should, however, be less than 2 wt. %, as by exceeding this upper limit an increased proneness to crack formation in the coating during deformation of a correspondingly coated steel flat product has been observed. The positive effects of the presence of silicon in a coating according to the invention, used if necessary within the scope of the invention, occur particularly reliably if the Si content of the metallic coating is at least 0.15 wt. %. In order to reliably exclude any potentially negative effects of the Si content on the deformability of the coating, it can be advantageous to limit the Si content of the Zn—Mg—Al coating alloyed according to the invention to less than 0.8% wt, in particular to up to a maximum of 0.25 wt. %.

Besides the Mg and Al contents, which are always present according to the invention, and the optional Si contents, to form certain properties a coating obtained according to the invention can optionally additionally also contain one or more elements from the group “Pb, Ti, Ni, Cu, Co, Mn, Cr, Sr, Fe, B, Bi, Cd, REM, Sn”, wherein (in wt. %) the contents of each should be: Pb<0.1%, Ti<0.2%, Ni<1%, Cu<1%, Co<0.3%, Mn<0.5%, Cr<0.2%, Sr<0.5%, Fe<3%, B<0.1%, Bi<0.1%, Cd<0.1%, REM (REM=Rare Earth Metals)<0.2% and Sn<0.5%.

Pb, Bi and Cd can be present to form a larger crystal structure (zinc spangle), Ti and B to improve the formability and the hardness and Cu, Ni, Co, Cr, Sr and Mn to positively influence the boundary layer reactions. The presence of Fe contributes positively to the desired phase formation. Sn can be added to positively influence surface oxidation and one or more “REM” rare earth metals, in particular lanthanum and cerium, can be added to improve the flow behaviour of the coating melt.

In order to prevent the presence of optionally present alloying elements “Si, Pb, Ti, Ni, Cu, Co, Mn, Cr, Sr, B, Bi, Cd, REM and Sn” having an effect in a coating alloyed according to the invention which is to the disadvantage of the effect of the main alloying elements Al and Mg, it is advantageous if the sum of the contents of these optionally added elements does not exceed 0.8 wt. %.

Included in the impurities which can be contained in a corrosion protection coating are, amongst others, the elements which as a result of the hot-dip coating get from the steel substrate into the coating, wherein the contents of these elements in the coating remain so low that the properties of the coating are not affected. The latter is especially guaranteed if the metallic coating contains at most 0.3 wt. % impurities.

The process according to the invention enables high Al and Mg contents to accumulate in the boundary layer bordering the steel substrate, while in the intermediate layer particularly low Al contents are present. It has become apparent that with the relatively low Al contents of a melt bath, used for carrying out the method according to the invention, the forming of the layer composition aimed for according to the invention can be directly influenced by suitably setting the strip dipping temperature and/or the bath temperature itself. A special importance is thereby attributed to the difference between the temperature of the strip during dipping and the temperature of the melt bath. By limiting this difference to a range from 10° C. to 60° C., it is ensured that a coating according to the invention forms with a layer composition which is optimum for its adhesion to the steel substrate and for its further processing properties.

Optimum corrosion protection properties of the metallic coating alloyed according to the invention can be obtained by its Mg content being at least 4.5 wt. %. Surprisingly, connected with that it has become apparent that with Mg contents limited to a maximum of 6.5 wt. %, in particular with Mg contents lying in a range from 4.5-6.5 wt. %, steel flat products according to the invention having an exceptionally good combination of properties can be produced with high production reliability.

In order to further improve the adhesion to the steel substrate and the ductility of the coating according to the invention, the Al content of the corrosion protection coating can be set to at least 1.0 wt. %. Limiting the Al content to a maximum of 1.5 wt. % additionally contributes to minimising the risk of excessive slag formation with a melt bath alloyed in the corresponding way.

With the method according to the invention for producing a with a metallic Zn—Mg coating, which protects against corrosion, on a steel flat product, firstly the steel flat product, preferably available as hot-rolled or cold-rolled strip, is heated to a bath-entry temperature which is in the range from 360-710° C. The difference between the bath-entry temperature and the melt bath should not, thereby, exceed 10-60° C., in order that the temperature of the melt bath can be kept constant without greater effort and in order to ensure that a layer composition forms in the coating obtained according to the invention, which guarantees, on the one hand, optimum adhesion to the steel substrate and, on the other hand, optimum protection against corrosion with good weldability and coatability with an organic coating agent.

Subsequently, the steel flat product heated in such a way is conveyed uninterrupted in the continuous pass through a Zn—Mg—Al melt bath heated to a melt bath temperature of 350-650° C., which in addition to zinc and unavoidable impurities has (in wt. %) 4-8% Mg and 0.5-1.8% Al. Practical tests have shown that particularly good production results are obtained if the melt bath temperature is held in the range from 430-490° C.

In the course of this, surprisingly it emerged that the melt bath could be held without any danger at this temperature even without exposure to protective gas, without a reaction of the magnesium with the ambient oxygen occurring, which negatively affects the quality of the coating.

As explained above in connection with the steel flat product obtained according to the invention, in addition optionally one or more of the following elements, having a content which is below the upper limit specified for each of these elements in each case, can be contained in the melt bath: Si: <2%, Pb: <0.1%, Ti: <0.2%, Ni: <1%, Cu: <1%, Co: <0.3%, Mn: <0.5%, Cr: <0.2%, Sr: <0.5%, Fe: <3%, B: <0.1%, Bi: <0.1%, Cd: <0.1%, REM<0.2%, Sn<0.5%.

At this point it should be pointed out that the alloying contents of the melt bath used to apply the coating according to the invention are to be found essentially identically in the finished coating.

Correspondingly, the settings of the contents of individual alloying elements mentioned here as advantageous, where appropriate, in connection with the alloying of the corrosion protection coating formed according to the invention, apply at all times for the alloying of the melt bath too.

After leaving the melt bath, the layer thickness of the metallic coating is adjusted in a way known per se by removing excess Zn—Mg—Al melt.

To guarantee its effect, the total thickness of the corrosion protection coating should be at least 3 μm, in particular at least 7 μm. Despite the corrosion protection coating having a greater layer strength and thickness, good weldability of the coating according to the invention is still guaranteed due to the setting, according to the invention, of its alloying contents and in particular of its Al content. The thickness of the coating should not, however, be set to greater than 20 μm, in order not to unduly impede deformation.

The Fe content of the melt bath is limited to at most 1 wt. %, in particular 0.5 wt. %, in order to keep slag formation on the melt bath at a low level.

The application of the invention is not limited to steel flat products which are produced from a certain steel grade, but is suitable for coating all steel strips and sheets on which particular demands are made relating to corrosion protection.

To prove the effectiveness of the invention, a large number of tests were carried out and the properties of the steel flat product samples 1-22, produced in each case and provided with a coating according to the invention, were determined. For comparison, in addition, steel samples R1, R2, R3 were produced, which were provided with a metallic coating in the conventional way which was supposed to protect them against corrosion.

The steel sheet samples 1 to 22 and R1, R2, R3 tested were produced from a conventional IF steel which in addition to iron and unavoidable impurities contained (in wt. %) C: 0.002.%, Si: 0.01%, Mn: 0.20%, P: 0.012%, S: 0.01%, Ti: 0.07% and Al: 0.04%.

The steel sheet samples 1-22 were annealed in the continuous pass at an annealing temperature TG and subsequently conveyed at a bath-entry temperature TE into a melt bath which was kept at a melt bath temperature TS and had, in addition to zinc and unavoidable impurities, contents of Mg and Al which were in the predefined range according to the invention.

The reference samples R1, R2, R3 manufactured for comparison were also annealed at a temperature TG and then conveyed at a bath-entry temperature TE through a melt bath kept at a melt bath temperature TS. In contrast to the melt bath used during coating of the samples 1 to 22 according to the invention, the melt bath used for the comparison, however, contained, in addition to Zn, contents of Al and Mg which were not in the predefined range according to the invention.

In Table 1, the annealing temperature TG, the bath-entry temperature TE, the respective melt bath temperature TS and the contents of Mg and Al in the Zn—Mg—Al coatings obtained in each case, are specified for the samples 1 to 22 according to the invention tested and for the reference samples R1, R2, R3. Furthermore, the respective contents of Mg and Al of the Zn—Mg—Al melt bath used respectively are listed in Table 1.

In Table 2, furthermore, the respective coating thickness D and the evaluation H of the hardness tested in the ball impact test according to SEP 1931 (“SEP 1931”=Stahl Eisen Prüfblatt [Steel Test Specification] 1931, Verlag [Publisher] Stahleisen GmbH, Edition 01.91) and the evaluation Z of the time are recorded, after which time in the salt spray test carried out according to DIN EN ISO 9227 SST the formation of red rust on the respective sample occurred.

For the evaluations H in the results of the ball impact test, “1” means no cracks, “2” means fine cracks, “3” means cracks and fine chipping and “4” means intense chipping.

For the evaluation Z in the results of the salt spray test, the following stages are applied: “1”: first red rust formation after less than 500 h, “2”: first red rust formation after 500-1000 h, “3”: first red rust formation after >1000-1500 h, “4”: first red rust formation only after more than 1500 h.

In addition, in Table 2 the results KF of the inspection, carried out according to VDA 621-415, of the samples 1-22 and R1, R2, R3 for corrosion on a sheet metal flange formed according to SEP 1160 (“SEP 1160”=Stahl Eisen Prüfblatt [Steel Test Specification] 1160, Verlag [Publisher] Stahleisen GmbH, Edition 06-2004) are recorded. The values specified in the respective column indicate the number of cycles passed through, which were passed through up to a red rust proportion exceeding 10%. Particularly good levels of resistance to corrosion are characterised by values above 10, while the values under 10 do not meet the requirements for resistance to corrosion in the flange.

Finally, in the last column of Table 2, the evaluation SE in the results of the weldability test (Resistance spot welding (RWS)) is recorded. The value “1” means that fewer than 200 spot welds, the value “2” that 200-500 spot welds and the value “3” that more than 500 spot welds were produced.

It becomes apparent that the adhesion of a coating composed and produced according to the invention to the samples 1-22 is at least on a par with the adhesion of the conventionally produced coatings of the reference samples R1, R2, R3. At the same time, the samples 1-22 coated according to the invention have a distinctly superior corrosion protective effect compared to the reference samples R1, R2, R3.

TABLE 1

| | | | | Coating | | Melt bath | |
|---|---|---|---|---|---|---|---|
| | TG | TE | TS | Mg | Al | Mg | Al |
| Sample | [° C.] | [° C.] | [° C.] | [% wt] | [% Wt] | [% wt] | [% wt] |
| 1 | 800 | 450 | 440 | 4.01 | 0.53 | 4.0 | 0.5 |
| 2 | 800 | 450 | 440 | 5.03 | 0.57 | 5.2 | 0.5 |
| 3 | 800 | 470 | 440 | 5.05 | 0.62 | 5.2 | 0.5 |
| 4 | 800 | 500 | 440 | 5.08 | 0.67 | 5.3 | 0.5 |
| 5 | 800 | 450 | 440 | 5.10 | 0.93 | 5.3 | 0.9 |
| 6 | 800 | 470 | 440 | 5.09 | 0.96 | 5.2 | 0.8 |
| 7 | 800 | 500 | 440 | 5.12 | 1.01 | 5.3 | 0.8 |
| 8 | 800 | 500 | 490 | 4.89 | 1.22 | 5.0 | 1.0 |
| 9 | 800 | 470 | 450 | 4.69 | 1.55 | 5.0 | 1.5 |
| 10 | 800 | 490 | 460 | 5.01 | 1.72 | 5.2 | 1.6 |
| 11 | 800 | 520 | 460 | 5.05 | 1.79 | 5.2 | 1.5 |
| 12 | 800 | 450 | 440 | 5.97 | 0.61 | 6.1 | 0.6 |
| 13 | 800 | 450 | 440 | 6.05 | 1.01 | 6.3 | 0.9 |
| 14 | 800 | 470 | 460 | 6.16 | 1.70 | 6.4 | 1.6 |
| 15 | 800 | 490 | 460 | 6.12 | 1.61 | 6.3 | 1.5 |
| 16 | 800 | 520 | 460 | 6.19 | 1.74 | 6.4 | 1.5 |
| 17 | 800 | 450 | 440 | 7.13 | 0.53 | 7.4 | 0.5 |
| 18 | 800 | 470 | 460 | 7.21 | 1.10 | 7.6 | 1.0 |
| 19 | 800 | 470 | 460 | 7.33 | 1.58 | 7.2 | 1.5 |
| 20 | 800 | 450 | 440 | 7.96 | 0.59 | 8.1 | 0.6 |
| 21 | 800 | 450 | 440 | 8.00 | 1.15 | 8.3 | 1.0 |
| 22 | 800 | 470 | 460 | 7.99 | 1.68 | 8.2 | 1.5 |
| R1 | 800 | 470 | 450 | 0.82 | 0.45 | 0.9 | 0.3 |
| R2 | 800 | 470 | 450 | 1.21 | 0.51 | 1.3 | 0.4 |
| R3 | 800 | 470 | 450 | 2.99 | 6.02 | 3.2 | 6.2 |

TABLE 2

| Serial | D | | | | |
|---|---|---|---|---|---|
| No. | [μm] | H | Z | KF | SE |
| 1 | 19.8 | 2 | 4 | 15 | 1 |
| 2 | 8.4 | 1 | 3 | 15 | 3 |
| 3 | 8.1 | 1 | 3 | 15 | 3 |
| 4 | 8.0 | 1 | 3 | 15 | 3 |
| 5 | 7.9 | 1 | 3 | 15 | 3 |
| 6 | 8.2 | 1 | 3 | 15 | 3 |
| 7 | 8.1 | 1 | 3 | 15 | 3 |
| 8 | 7.3 | 1 | 3 | 15 | 3 |
| 9 | 7.2 | 11 | 3 | 15 | 3 |
| 10 | 7.4 | 1 | 3 | 15 | 3 |
| 11 | 7.5 | 1 | 3 | 15 | 3 |
| 12 | 3.8 | 1 | 2 | 5 | 3 |
| 13 | 3.0 | 1 | 2 | 5 | 3 |
| 14 | 7.4 | 1 | 3 | 15 | 3 |
| 15 | 7.6 | 1 | 3 | 15 | 3 |
| 16 | 7.3 | 1 | 3 | 15 | 3 |
| 17 | 7.7 | 2-3 | 3 | 10 | 3 |
| 18 | 7.0 | 2 | 3 | 20 | 2 |
| 19 | 8.0 | 1-2 | 4 | 20 | 2 |
| 20 | 7.6 | 2-3 | 4 | 10 | 2 |
| 21 | 13.5 | 2 | 4 | 20 | 2 |
| 22 | 10.4 | 1-2 | 4 | 20 | 2 |
| R1 | 7.2 | 1-2 | 1 | 5 | 3 |
| R2 | 7.4 | 1-2 | 1 | 5 | 3 |
| R3 | 7.8 | 2-3 | 4 | 10 | 1 |

1. A steel flat product having a metallic coating which protects against corrosion and which in addition to zinc and unavoidable impurities, comprises in wt. %:
Mg: 4-8%
Al: 0.5-1.8%
and optionally one or more of the following:
Si: <2%, Pb: <0.1%, Ti: <0.2%, Ni: <1%, Cu: <1%, Co: <0.3%, Mn: <0.5%, Cr: <0.2%, Sr: <0.5%, Fe: <3%, B: <0.1%, Bi: <0.1%, Cd: <0.1%, REM<0.2%, and Sn<0.5%.

2. The steel flat product according to claim 1, wherein the Mg content of the metallic coating is at least 4.5 wt. %.

3. The steel flat product according to claim 1, wherein the Mg content of the metallic coating is a maximum of 6.5 wt. %.

4. The steel flat product according to claim 1, wherein the Al content of the metallic coating is at least 1.0 wt. %.

5. The steel flat product according to claim 1, wherein the Al content of the metallic coating is a maximum of 1.5 wt. %.

6. The steel flat product according to claim 1, wherein a sum of the contents of the elements Si, Pb, Ti, Ni, Cu, Co, Mn, Cr, Sr, B, Bi, Cd, REM, and Sn optionally present in the metallic coating is a maximum of 0.8 wt. %.

7. The steel flat product according to claim 1, wherein the metallic coating contains at most 0.3 wt. % impurities.

8. A method for producing a metallic Zn—Mg coating, which protects against corrosion, on a steel flat product, comprising the following production steps completed in a continuous pass:
Annealing the steel flat product at an annealing temperature of 500-900° C.;
Cooling the steel flat product to a bath-entry temperature which is in a range from 360-710° C.;
Conveying the steel flat product through a Zn—Mg melt bath heated to a melt bath temperature of 350-650° C., which in addition to zinc and unavoidable impurities comprises (in wt. %):
Mg: 4-8%
Al: 0.5-1.8%
and optionally one or more of the following:
Si: <2%, Pb: <0.1%, Ti: <0.2%, Ni: <1%, Cu: <1%, Co: <0.3%, Mn: <0.5%, Cr: <0.2%, Sr: <0.5%, Fe: <3%, B: <0.1%, Bi: <0.1%, and Cd: <0.1%; and
Adjusting a thickness of the metallic coating by removing excess Zn—Mg melt.

9. The method according to claim 8, wherein the Fe content of the melt bath is limited to at most 1 wt. %.

10. The method according to claim 8, wherein the melt bath temperature is 430-490° C.

11. The method according to claim 8, wherein a difference between the bath-entry temperature of the steel flat product and the melt bath temperature is 10-60° C.

12. The method according to claim 8, wherein the thickness of the metallic coating is 3-20 μm.
